(19) United States
(12) Patent Application Publication
(10) Pub. No.: US 2023/0218114 A1
(43) Pub. Date: Jul. 13, 2023

(54) FOOD PROCESSING TOOL AND METHOD OF MANUFACTURE

(71) Applicant: DE'LONGHI BRAUN HOUSEHOLD GMBH, Neu-Isenburg (DE)

(72) Inventors: Pascal WOHLFAHRT, Neu-Isenburg (DE); Christoph EISSENGARTHEN, Neu-Isenburg (DE)

(21) Appl. No.: 18/007,655

(22) PCT Filed: Jul. 2, 2021
(86) PCT No.: PCT/EP2021/068420

§ 371 Date: Dec. 1, 2022

(30) Foreign Application Priority Data
Jul. 10, 2020 (GB) 2010622.5
Jul. 10, 2020 (LU) 101909

(51) Int. Cl. A47J 43/07

(52) U.S. Cl. CPC A47J 43/0711; A47J 2043/04427

(57) ABSTRACT

Food processing tool and method of manufacture Food processing tool (100) has a housing 110 defining a volume therein. The tool (100) includes a drive-shaft (102) that drives a bladed tool 130 attached thereto about an axis of rotation. An insert 120) is located and arranged in the housing (110) so as to define a processing volume open to an outside of the housing through an opening thereof. The insert (120) is integral with the housing (110).

### FIELD

The present invention relates to a food processing tool and a method of manufacturing the same.

### BACKGROUND

A blender is a kitchen appliance typically having a motor unit attached to a rotary blade that is used for blending, chopping, crushing etc. food material. A variant of this known as a “hand blender” involves the motor unit being sized and weighted so as to be hand-held, with the blade being provided on a shaft extending away from the motor unit.

In order to allow safe operation of a blending appliance, it is necessary to partially surround the rotary blade with a protective housing. This housing typically extends above the blade and around it. A particular variant of this, known as a “bell”, is bell-shaped—that is, it extends away from the shaft and towards the direction of extension of the shaft at an angle of more than 90 degrees, and preferably more than 135 degrees measured in an arc extending from, at one extremity, the shaft along its extension towards the motor, to the other extremity facing towards the direction of extension of the shaft away from the motor (i.e., the maximum angle). This sloped shaped helps ensure that food flowing down the shaft towards the housing does not get stuck on any protruding surface but instead continues to flow along sloped surfaces toward the open end of the housing.

However, these housings introduce a problem of ensuring that food material flows to the blade to be processed and does not simply co-rotate with the blade, and that dead-zones within the blender housing in which food is not processed are avoided. As the bell-shape requires that the housing extends for some distance above the rotary blade in order to accommodate the blade whilst still forming a suitably sloped surface, this problem is particularly acute in bell-shaped housings as the space thus formed above the blade by the sloped housing is very likely to become a dead-zone.

One solution for the problem of guiding food towards the blades is to provide ribs within the housing extending from a side of the housing towards the blades to guide food flowing around the inside of the housing towards the blades. For example, pat. pub. no. GB2469639A teaches providing ribs on a side of the housing extending inwardly towards the blades. However, this solution does not solve the problem of food-flow and dead-spaces above the blades.

Pat. pub. no. DE102015207196B3 discloses one proposed solution to the issue of dead-zones in that the space above the blade within the bell is divided by a dividing wall so as to reduce the space above the blade and avoid the formation of a dead-zone there.

However, this suffers from the drawback that the divider prevents food flowing within the bell from contacting the ribs above the divider preventing them from guiding food towards the blades from above. The seal between the divider and the bell may also be poor which may permit food ingress into the space above the divider.

Pat. Pub. no. DE102013219835A1 discloses providing a plastic cover having ribs provided thereon to divide up the bell-shaped housing. The concave shape of this cover requires excessively deep ribs which food can become trapped between. These ribs furthermore extend all the way to the exterior of the cover thus complicating its design and attachment to the exterior. Finally, this design suffers from the problem of a poor seal between the cover and the bell which permits food ingress between the cover and the bell and prevents it being washed effectively in a dishwasher.

The present invention aims to at least partially ameliorate the above-described problems of the prior art.

### SUMMARY OF THE INVENTION

In an aspect of the invention, a food processing tool is disclosed having a housing defining a volume therein, the tool comprising a drive-shaft configured to drive a bladed tool attached thereto about an axis of rotation, and an insert located and arranged in the housing so as to define a processing volume open to an outside of the housing through an opening thereof, wherein the insert is integral with the housing. This is advantageous as providing an insert integral with the housing may help to reduce a ‘dead zone’ above the bladed tool while improving a seal between the insert and the housing.

As used herein, parts being “integral with” each other may preferably connote that they are not separable from each other non-destructively. Parts “integral with” each other may comprise parts that have been made integral with each other by, for example, welding, brazing, or adhering. As used herein, the term ‘insert’ preferably connotes an item which is inserted into/onto a further item, and may connote an item that is distinct from the further item. As used herein, the terms ‘insert’ and ‘integral’, when used together, preferably refer to an item which is inserted (suitably during manufacture) into/onto a further item and then (once inserted) is integral with that further item. That is, the insert is preferably initially (prior to assembly) a separate component, but after assembly is not non-destructively separable from the tool.

Preferably, the insert comprises ribs extending from a surface of the insert into the processing volume. This is advantageous as the ribs may help guide the food towards the blade for improved cutting. The surface is preferably a generally flat surface.

In another aspect of the invention, a food processing tool is disclosed comprising a rotary knife (and/or a mount for the same) and a housing comprising a roof surrounding the rotary knife axially on one side (i.e. surrounding an axis of the rotary tool). Preferably, the rotary knife is mounted on the roof or extends away from the roof. A skirt surrounds the knife, preferably (at least partially) radially about a periphery of a volume of rotation of the knife. The skirt comprises protrusions extending radially inwards towards the volume of rotation of the knife, and the roof comprises ribs extending axially towards the knife and radially between the protrusions. This structure enhances flow towards the knife. The roof may be the surface of the insert described herein.

In another aspect of the invention, a bell for a food processing tool is disclosed comprising a surface and a skirt for the surface, the skirt having inwardly extending protrusions and the surface having inwardly/downwardly extending ribs, the ribs being preferably arranged so as to correspond with gaps between the protrusions.

Preferably, the ribs are separated from the housing/skirt by a gap, and optionally the insert is welded to the housing. Preferably the gap is at least 1 mm. More preferably the gap is at least 2.5 mm. Yet more preferably the gap is in the range 2.5-3 mm. This is advantageous as the tool may be constructed more cheaply, because the gap better enables welding of the insert to the housing.

Preferably, the ribs extend (generally) radially substantially at a right-angle to the axis of rotation over the majority of their length. Preferably the ribs extend either directly radially, and not tangentially, from a central boss of the insert or from an imaginary cylinder concentric with the axis of rotation. This can ensure an even effect along the length of the bladed tool.

The ribs optionally each respectively comprise a forward slope, and a reverse slope, wherein a minimum angle formed by the forward slope relative to a direction of rotation of the bladed tool is steeper than that of the reverse slope, and more preferably the forward slope forms an angle of approximately 45 degrees. This can ensure less turbulent flow and better processing of food.

The ribs preferably curve away (with distance from an axis of rotation of the tool) from a direction of rotation of the bladed tool, and more preferably the ribs are curved to conform to a spiral/twisted shape of the housing and/or a curvature of blades of the bladed tool. Conforming to the spiral/twisted shape of the housing can enhance flow of food from the housing to the area in which the food is processed. Conforming to the shape of the blades can enhance pressure beneath the blades.

Optionally, the housing comprises radial maxima and minima (that is, outwardly protruding portions and inwardly protruding portions) configured to guide food flowing around an inside of the housing away from the housing. This prevents food material staying near the housing and not being processed.

Preferably, the insert is shaped to conform to the radial maxima and minima. This can ensure a tight seal and simple construction, with the radial maxima being available over the entire surface of the housing that is exposed and with no need for the housing to have a transition area between the maxima/minima and the insert.

Optionally, the ribs extend into the radial maxima (i.e., into that portion of the insert that extends into the radial maxima and between the radial minima). This provides more space for the ribs.

The opening of the housing optionally comprises axial maxima and minima (that is, upwardly and downwardly protruding portions), preferably wherein the radial maxima and minima respectively correspond to the axial maxima and minima. These axial maxima and minima can ensure that food continues to flow into the housing even when the opening of the housing is pressed against a surface. Having the axial maxima and minima correspond to the radial maxima and minima can also ensure that food material enters the housing closer to the bladed tool.

The insert is preferably sealingly welded to the housing so as to seal against liquid ingress between the housing and the insert. This is advantageous as it can prevent liquid ingress into the space above the insert in use or during cleaning of the tool.

The housing and the insert are made of dishwasher and/or food-safe material, preferably stainless steel.

An exterior of the housing may optionally form a maximum angle of 90 degrees or more to the axis of rotation. Preferably, 135 degrees or more. The housing may optionally be bell-shaped. Food material may thus flow down the housing more easily.

In an aspect of the invention, a food processing tool is disclosed having a housing defining a volume therein, the tool comprising a drive-shaft configured to drive a bladed tool attached thereto about an axis of rotation. An insert is located and arranged in the housing so as to divide the volume into a processing volume open to an outside of the housing through an opening thereof, and a second volume, the insert having ribs extending from a surface thereof into the processing volume. The ribs are separated from the housing by a gap, and the insert is welded to the housing, preferably wherein the gap is at least 1 mm, more preferably at least 2.5 mm and yet more preferably is in the range 2.5-3 mm.

This is advantageous as it may be constructed more cheaply, because the gap better enables welding of the insert to the housing.

The insert may be sealingly welded to the housing so as to seal the second volume against liquid ingress therebetween. This is advantageous as it can prevent liquid ingress into the second volume during use.

Optionally, the housing comprises radial maxima and minima (that is, outwardly protruding portions and inwardly protruding portions) configured to guide food flowing around an inside of the housing away from the housing. This prevents food material staying near the housing and not being processed.

Preferably, the insert is shaped to conform to the radial maxima and minima. This can ensure a tight seal and simple construction, with the radial maxima being available over the entire surface of the housing that is exposed and with no need for the housing to have a transition area between the maxima/minima and the insert.

More preferably the ribs extend into the radial maxima (i.e., into that portion of the insert that extends into the radial maxima and between the radial minima). This provides more space for the ribs.

The opening of the housing optionally comprises axial maxima and minima (that is, upwardly and downwardly protruding portions), preferably wherein the radial maxima and minima respectively correspond to the axial maxima and minima. These axial maxima and minima can ensure that food continues to flow into the housing even when the opening of the housing is pressed against a surface. Having the axial maxima and minima correspond to the radial maxima and minima can also ensure that food material enters the housing closer to the bladed tool.

The ribs may preferably extend radially substantially at a right-angle to the axis of rotation over the majority of their length. This can ensure an even effect on the bladed tool.

Preferably less than 70% of an internal surface area of the housing is enclosed by the second volume. This can ensure greater utilisation of the surface of the inside of the housing by leaving more than 30% of the inner surface area of the housing still accessible to food.

The ribs optionally each respectively comprise a forward slope, and a reverse slope, wherein a minimum angle formed by the forward slope relative to a direction of rotation of the bladed tool is steeper than that of the reverse slope, and more preferably the forward slope forms an angle of approximately 45 degrees. This can ensure less turbulent flow and better processing of food.

The ribs preferably curve away from a direction of rotation of the bladed tool, and more preferably the ribs are curved to conform to a spiral/twisted shape of the housing and/or a curvature of blades of the bladed tool. Conforming to the spiral/twisted shape of the housing can enhance flow of food from the housing to the area in which the food is processed. Conforming to the shape of the blades can enhance pressure beneath the blades.

The housing and the insert are made of dishwasher and/or food-safe material, preferably stainless steel.

The housing may optionally be bell-shaped. Food material may thus flow down the housing more easily.

A food processing appliance is disclosed comprising either of the above-mentioned tools.

In another aspect of the invention, a method of manufacturing a food processing tool is disclosed, comprising steps of:
a) stamping, punching, or cutting sheet metal to produce a shaped blank,
b) stamping and/or deep-drawing the blank to produce an insert bearing ribs, preferably ribs that do not extend all the way to an edge of the insert,
c) welding, preferably laser-welding, the insert to a housing.

This method is advantageous as it cheaply produces a single-piece tool having ribs.

Optionally step a) and step b) are carried out simultaneously and/or by stamping/punching with the same die. This makes manufacturing cheaper and quicker.

In another aspect of the invention, a hand-blender attachment is disclosed having a bell-shaped housing divided by a planar insert such that more than 30% of the inner surface area of the housing is accessible to food from the outside.

In another aspect of the invention, a food processing appliance is disclosed having a housing, a motor, a food processing knife driven by the motor, a removable insert for dividing up a volume of the housing, a sensor for detecting the presence and/or absence of the insert, and a processor configured to prevent and/or allow and/or limit energizing of the motor based on feedback from the sensor.

In another aspect of the invention, a hand-blender attachment is provided having a shaft-alley and a bell-housing within which a food processor knife is provided, the food processor knife is attached to a drive-shaft that extends through the shaft-alley, and the attachment is sealed against liquid ingress through an opening of the bell-housing by a welded barrier provided in the bell-housing.

In another aspect of the invention, a hand-blender attachment is provided having a food processing housing having a first set of ribs protruding radially inwards from a side of the housing towards a food processing knife of the attachment, and a second discrete set of ribs protruding axially from a ceiling of the inside of the housing towards the knife. Providing axial and radial ribs discretely (that is, separately so that one is not a continuation of the other) in this fashion avoids the need for a transition between the two and allows radial and axial rib interaction with the knife at different points in the rotation of the knife, balancing forces and making operation smoother.

The invention also encompasses a kit of parts for constructing any of the apparatuses or apparatus elements herein described.

Any apparatus feature as described herein may also be provided as a method feature, and vice versa. As used herein, means plus function features may be expressed alternatively in terms of their corresponding structure, such as a suitably programmed processor and associated memory.

Any feature in one aspect of the invention may be applied to other aspects of the invention, in any appropriate combination. In particular, method aspects may be applied to apparatus aspects, and vice versa. Furthermore, any, some and/or all features in one aspect can be applied to any, some and/or all features in any other aspect, in any appropriate combination.

It should also be appreciated that particular combinations of the various features described and defined in any aspects of the invention can be implemented and/or supplied and/or used independently.

In this specification the word ‘or’ can be interpreted in the exclusive or inclusive sense unless stated otherwise.

Furthermore, features implemented in hardware may generally be implemented in software, and vice versa. Any reference to software and hardware features herein should be construed accordingly.

Whilst the invention has been described in the field of domestic food processing and preparation machines, it can also be implemented in any field of use where efficient, effective and convenient preparation and/or processing of material is desired, either on an industrial scale and/or in small amounts. The field of use includes the preparation and/or processing of: chemicals; pharmaceuticals; paints; building materials; clothing materials; agricultural and/or veterinary feeds and/or treatments, including fertilisers, grain and other agricultural and/or veterinary products; oils; fuels; dyes; cosmetics; plastics; tars; finishes; waxes; varnishes; beverages; medical and/or biological research materials; solders; alloys; effluent; and/or other substances, and any reference to “food” herein may be replaced by such working mediums.

The invention described here may be used in any kitchen appliance and/or as a stand-alone device. This includes any domestic food-processing and/or preparation machine, including both top-driven machines (e.g. stand-mixers) and bottom-driven machines (e.g. blenders). It may be implemented in heated and/or cooled machines. It may be used in a machine that is built-in to a work-top or work surface, or in a stand-alone device. The invention can also be provided as a stand-alone device.

### BRIEF DESCRIPTION OF DRAWINGS

One or more aspects will now be described, by way of example only and with reference to the accompanying drawings having like-reference numerals, in which:

FIG. 1 shows a side-on, cut-away drawing of a tool according to the present invention;

FIG. 2 shows a close-up of a section of the open end of the tool of FIG. 1;

FIG. 3 shows a perspective view of the tool of FIG. 1 seen from its open end;

FIG. 4 shows a view in plan of the open end of the tool of FIG. 1;

FIG. 5 shows a perspective view of a bell-insert of the tool of FIG. 1;

FIG. 6 shows a section through a rib of the insert of FIG. 3 along a direction transverse to its direction of radial extension;

FIG. 7 shows a section through a rib of the insert of FIG. 3 along the direction of radial extension of the rib;

FIG. 8 shows a side-on view of the blade and insert of FIG. 1; and

FIG. 9 shows a highly schematic and simplified drawing of an appliance incorporating the tool of FIG. 1 in section.

### SPECIFIC DESCRIPTION

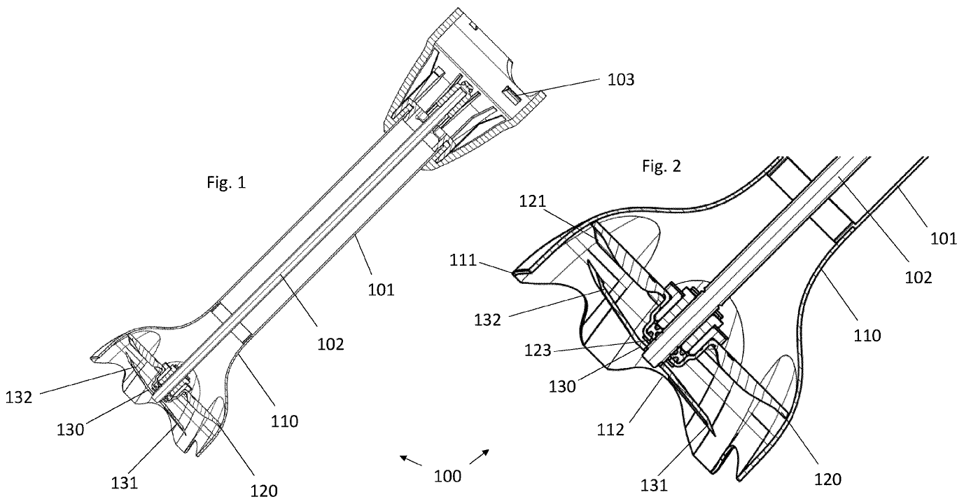

FIGS. 1 and 2 show a tool 100 (in this case a hand-blender attachment) with a shaft-alley 101 extending away from an attachment formation 103 which can be used to attach the attachment 100 to a motor unit 200 (shown labelled in FIG. 9). A drive shaft 102 extends within the shaft-alley 101 towards and into the bell 110. The shaft alley 101 opens into the bell 110. The bell 110 extends from its narrow end which is connected to the shaft alley 101, away from the shaft alley 101 towards a wider opening which forms a peripheral skirt.

The bell 110 has smooth, sloping lines which facilitates material to run off it during use and subsequent cleaning. Preferably this means that the bell 110 extends at an angle of more than 90 degrees, and more preferably more than 135 degrees to the major axis of the shaft-alley 101 (which will, in use, typically be oriented vertically) as measured in an arc which at one extremity faces in the direction of the motor unit and in the other faces away from it, and which swings away from the surface of the shaft-alley 101 as depicted in FIG. 7. Food material dripping down the bell is thus not presented with a flat surface, or even better not presented with a shallow slope (e.g., less than 45 degrees to the horizontal), and thus will be less likely to be retained and more easily washed off.

The bell 110 may be removably attached to the shaft alley 101 (e.g., using a screw and corresponding thread, snap fitting, or other removable attachment means) or it may be integrally formed with it. Similarly the shaft alley 101 may either be integrally formed with the motor unit 200, or removably attached thereto using a removable attachment means 103 which may be any of a screw fitting, button-actuated resilient locking means, snap-fitting or other suitable releasable locking means. Integral formation simplifies manufacturing, whilst removable attachment facilitates removing for cleaning away from the motor unit 200.

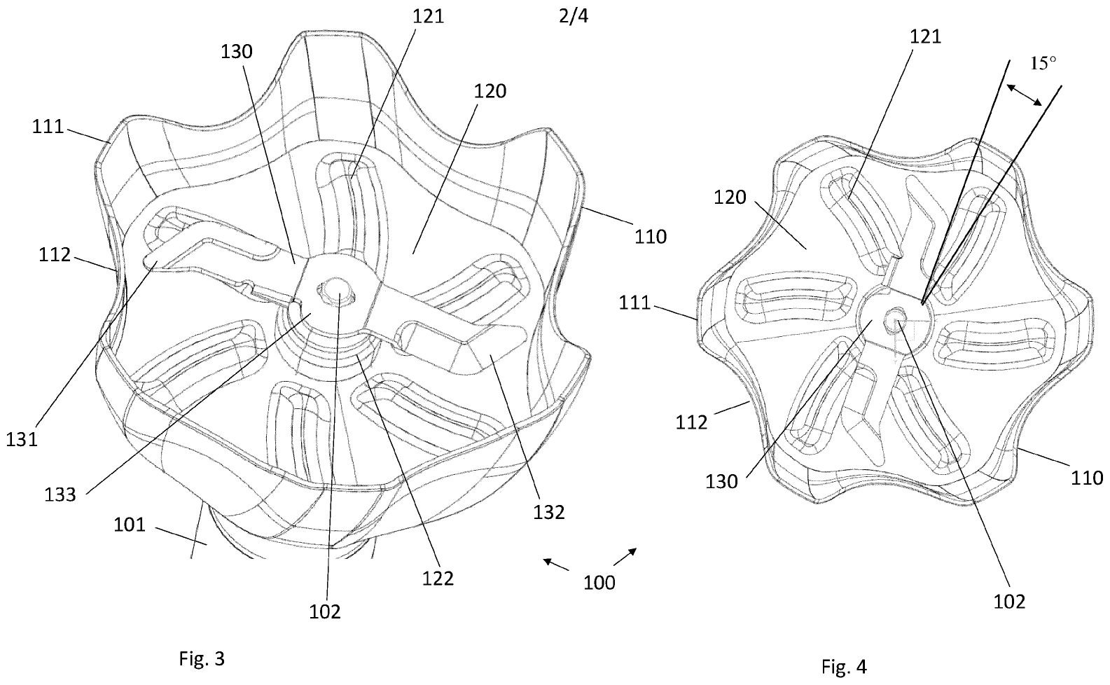

As is shown in FIGS. 3 and 4, a rotary knife 130 is provided on the end of the shaft 102 to process food within the bell 110. The knife 130 has two blades, 131 and 132 extending radially from a central hub 133. One, upper blade 131, as well as extending radially away from the shaft 102 also extends axially away from the shaft 102 towards the opening of the bell 110. The other, lower blade 132 also extends axially towards the narrower end of the bell 110 away from the opening as well as extending radially. In this way, the area swept by the knife 130 on each rotation is increased.

As is shown in both FIG. 3 and FIG. 7, the cutting edges of the upper blade 131 and lower blade 132 are formed at the apex where a horizontal (i.e., right-angle to the axis of rotation of the knife 130) surface meets a surface sloped relative to the horizontal. The sloped surface of the upper blade 131 faces that of the lower blade 132, thus serving to urge food in to the path of the other blade. The blades 131 and 132 are also angled backwards along their direction of rotation towards their outer extremity so as to better cut food trapped between the blade 130 and the bell 110.

The central hub 133 is either provided with a removable attachment means for attaching to the shaft 102 (e.g., thread which mates with matching screw thread provided on the shaft) or is integrally formed with it via, e.g., welding.

The bell 110 forms a radial wave-pattern along its exterior (i.e., the “skirt”), creating maxima 111, that is, points of maximum radial extension of the bell 110 away from the knife 130. Between the maxima 111, minima 112 are formed by the bell 110 where the bell 110 most closely approaches the knife 130 and protrudes towards it. These maxima 111 and minima 112 help guide food towards the knife 130 to be processed by it. The wave-pattern may be sine-wave, saw-tooth, zig-zag, or any suitable shape, however a relatively smooth pattern, lacking minimum angles of 90 degrees or less between neighbouring surfaces, is preferred to avoid creating food traps.

The maxima 111 may also form points of maximum axial extension of the skirt of the bell 110 away from the shaft-alley 101, with the minima 112 forming points of minimal axial extension. This creates crenellations along the skirt of the bell 110 that mean that when the open end of the bell 110 is pushed against a flat surface, such as the bottom of a bowl, food material can still enter and leave the bell 110 via the gaps between the crenellations. This may be provided in an axial wave-pattern similar to the radial wave-patterns discussed above. It is desirable that the radial minima 112 also correspond to the axial minima 112, as this means that food will enter into the bell 110 closer to the knife 130.

As shown in FIG. 3 and FIG. 4, the bell 110 preferably forms a twisted or spiral-like shape, such that the rotational location of the radial maxima 111 and minima 112 relative to the axis of rotation of the knife 130 changes along it. This helps conform the bell 110 to the flow of food-material over it when it is immersed in food material during use. The bell 110 may curve inwardly towards its opening from its maximum diameter in order to partially surround the knife 130 on three sides to enhance the wave-effect.

An insert 120 is located within the bell 110, dividing up the interior of the bell 110 and preventing excessive head-space above the blade 130 within the bell 110 in which food may collect and not be processed by the knife 130. The insert 120 thus forms a “roof” above the knife 130 during use. The insert 120 is integral with the bell 110. In particular, the insert 120 may be integrally attached to the bell 110 by, for example, welding, and preferably by laser-welding which is an efficient way of welding metal components.

Preferably the insert 120 is sealingly joined to the bell 110, to prevent food material and water ingress into the space above the insert 120 during use and cleaning. Preferably this sealed connection is formed by welding as described above. Such a seal obviates the need to provide a seal between the bell 110 and the shaft-alley 101.

The insert 120 preferably covers less than 70% of the surface of the inside of the bell 110 to allow it to be used to the greatest extent. For example, 30-90% may be uncovered, and more preferably 40-80% may remain accessible and in contact with food. In the example shown in FIG. 2, measuring from the point where the bell 110 meets the radius of the shaft alley 101 towards the opening of the bell 110, roughly 59% surface area of the inside of the bell 110 is covered by the insert 120, with roughly 41% remaining accessible to food being processed by the blade 130. This greater utilisation of space and materials compared to the prior art is enabled by the planar shape of the insert 120 in combination with the wave-shape of the bell 110, as opposed to trying to provide ribs acting both axially and radially on the insert 120 only.

The insert 120 is shaped as a planar board or sheet. For example, it may be formed by punching sheet-metal using a shaped die. This may be done at the same time as forming the ribs 121, and may potentially be done with the same die. The periphery of the insert 120 is preferably shaped to conform to the radial wave-pattern of the bell 110.

Ribs 121 are provided on the surface of the insert 120 extending axially towards the blade 130, extending radially away from the central boss 122. The ribs 121 preferably extend radially substantially at a right-angle to the axis of rotation of the knife 130 over the majority of their length in order to provide an even distance between the ribs 121 and the knife 130. The ribs 121 also extend along the surface of the insert 121 toward the bell 110. Preferably the rotational location of the ribs 121 corresponds to that of the maxima 111 of bell 110, and preferably not that of the minima 112, to accommodate additional rib-length and facilitate in-flow of food material over the minima 112.

Whilst a one-for-one correspondence is shown between the ribs 121 and the maxima 111 in FIG. 1, there may be fewer ribs 121 than maxima 111, or one or more maxima 11 may have more than one rib corresponding to it. The ribs 121 and maxima 11 are preferably symmetrically arranged so as to balance forces and reduce vibration and to generate an even flow of material all around the bell.

As shown in FIG. 2, the ribs 121 are curved radially along their radial extent with the concave side facing the blades 131 & 132 as they rotate towards them. For example, they may curve so as to form an angle of 15 degrees to the inner, flat section of the blades 131, 132 of the knife 130. The radius of the curvature (i.e., the radius of a circle for which the curvature of the ribs 121 is an arc) is preferably in the range of 25-50 mm, and more preferably approximately 32.5 mm. This curvature helps the ribs 121 conform the spiral-shaped flow of food towards the blades. To further improve this conformance, the curvature of the ribs 121 should essentially be a continuation of the spiral/twisted shape of the bell 110. Preferably, the curvature of the ribs 121 is in the same direction as the curvature of the blades 131 and 132 of the knife 130 to maximise instantaneous pressure under the blade 130 when the blades 131 and 132 pass over the ribs 121. To conform to the straight radial extension of the blades 131 and 132 from the central boss 122, at the point of the ribs 121 closest to the central boss 122 (either touching the boss 122 or extending from an imaginary cylinder concentric with it), the ribs 121 preferably extend directly, in a straight line radially from the axis of rotation, and not tangentially to it.

As shown in FIGS. 3 and 4, each rib 121 has a forward slope 121a and a reverse slope 121b. The forward slope 121a faces towards the blades 131 and 132 as of the knife 130 as it rotates towards the rib 121, that is, the forward slope 121a faces in an opposite direction to that in which the blade 130 rotates. The reverse slope 121b face away from the oncoming blades 131 and 132 of the knife 130, and towards the direction of rotation of the knife 130.

The forward slope 121a slopes at an angle of approximately 135 degrees to the surface of the insert 120 directly adjacent to it. This means that viscous food material and smaller solid pieces flowing along the surface of the insert 120 impacts on the forward slope 121a at a minimum angle of 45 degrees to its direction of flow and will tend to be directed at a right-angle away from the insert 120 and towards the knife 130. Larger solid food pieces will tend to be either similarly deflected or stopped against the ribs 121 and then hit by the knife 130 thus preventing co-rotation with the knife 130. A forward slope 121a having a slope angle substantially smaller than 135 degrees may be beneficial for stopping harder foods, however in more liquid foods turbulence may result as more food is deflected back towards the direction of rotation of the knife 130 against the oncoming flow of the food. 135 degrees is therefore a happy compromise.

The reverse slope 121b slopes at an angle of approximately 145 degrees to the surface of the insert 120 adjacent to it. Making the reverse slope 121b less steep than the forward slope 121a serves to reduce turbulence in viscous and liquid foods.

As seen in FIGS. 1 and 3, a central boss 122 extends axially from the insert 120 and has an upper aperture through which the shaft 102 extends into the working space of the bell 110. The boss 122 serves as a bearing on which the knife can rotate at a suitable axial height above the ribs 121, and protects the extension of the shaft 102 into the working space of the bell 110 in which food is processed. A sealing ring 123 or similar sealing arrangement is provided within the aperture of the boss 122 that prevent liquid flowing around the shaft 102 into the area enclosed between the bell 110 and the insert 120.

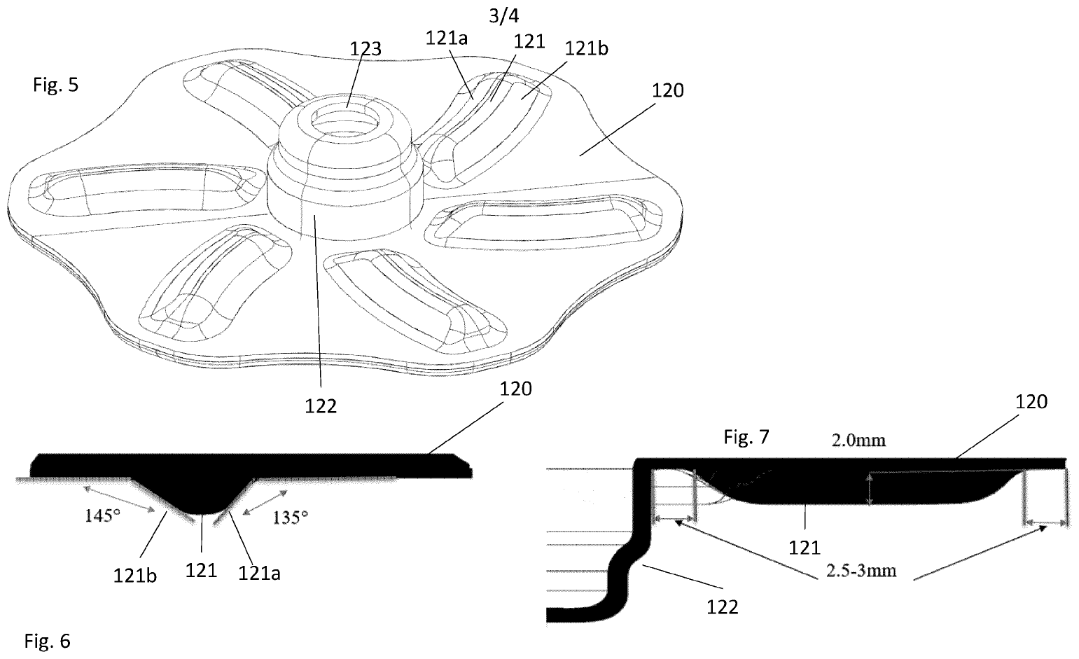

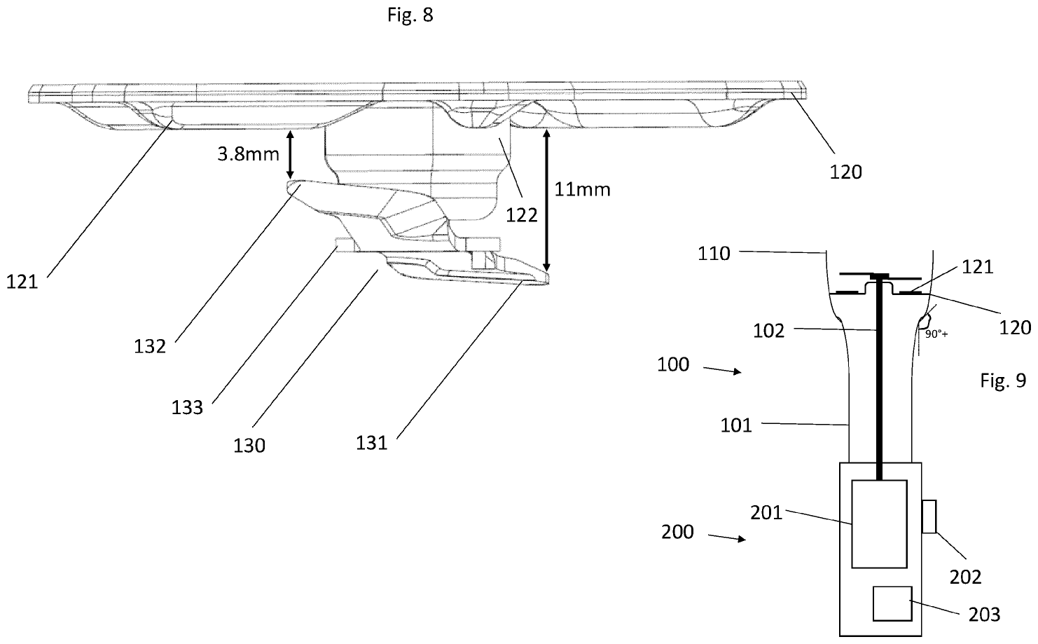

As seen in FIG. 5, a gap of at least 1 mm, preferably at least 2.5 mm and approximately 2.5-3 mm can formed between the outermost extremity of the ribs 121 and the outermost radial extremity of the insert 120. This helps facilitate joining of the insert 120 with the bell 110. For example, leaving a gap of sufficient width between the end of the rib 121 and the periphery of the insert 120 means that a laser can shine onto the join between the insert 120 and the bell 110 to weld them together more easily, and without having to adapt to changes in height of the insert 120. Additionally or alternatively, a similar gap can be left between the rib 121 and the boss 122 to facilitate machining of the boss 122.

As is also shown in FIG. 5, the ribs 121 preferably protrude at least approximately 2 mm from the flat surface of the insert 120. This gives sufficient rib-height to have an effect on food flowing along the flat surface of the insert 120, whilst avoiding problems with e.g., machine associated with excessive rib-height.

FIG. 6 illustrates the height of the blades 131 and 132 of the knife 130 above the ribs. The minimum axial distance from the lower blade 132 to the height of the ribs 121 is roughly 3-4 mm, whilst the maximum axial distance of the upper blade extending above the height of the ribs 121 is approximately 10-12 mm. The average axial distance of the blades 131 and 132 from the height of the ribs 121 above the insert 120 is approximately 5-8 mm. The average axial distance between the top of the ribs 121 and the knife 130 is less than approximately ½th of the maximum radial extent of the blades 131 and 132. For example the radial extent of the blades 131 and 132 may be 21.5 mm, the minimum axial distance of the knife 130 above the ribs 121 may be 3.8 mm, and the maximum axial distance of the knife above the ribs 121 may be 11 mm, with the knife 130 having an average distance of 7.4 mm axially from the ribs 121. The ratio between the axial height of the ribs 121 above the flat surface of the insert 120, and the axial height of the knife 130 above the ribs 121, may thus be in the approximate range of 1:2-1:5. This height gives a good compromise between allowing sufficient headspace between the knife 130 and the insert 120 to allow food to be processed in and preventing potential clash between the knife 130 and the ribs 121, excessive rib-depth that may prevent the effect of the knife reaching between the ribs 121, and allowing too much headspace between the knife 130 and the insert 120 in which food may collect unprocessed.

As is shown in FIG. 9, the tool 100 has a motor-unit 200 containing a motor 201 that connects to the drive shaft 102 via, for example, a disengageable clutch. A user-interface 202 such as, for example, a control knob, sliding switch, or touch-screen interface is provided on the outside of the motor unit 200 to allow the user to input instructions and receive feedback. For example, the user may use the user-interface to control a speed of the motor 201, and/or receive aural feedback regarding a status of the tool 100 from e.g., a speaker of the user interface 202.

Both the motor 201 and the user interface 202 are provided in electronic communication, for example a wired communication, with a central processing unit 203. This central processing unit 203 can control the motor 201 based on input into the user interface 202, and convert feedback from sensors, for example temperature and/or torque sensors, associated with the bell 110 and/or motor 201 about the status of the food being processed.

The central processing unit 203 may also selectively prevent, allow, or limit energising of the motor 201 based on feedback from sensors associated with the bell 110. For example, if the insert 120 is provided as removably-attachable to the bell 110, then the bell 110 may include a presence-sensor (for example, a micro-switch actuated by a protrusion on the insert 120) to detect whether the insert 120 is present. The central processing unit 203 may then prevent or limit energising of the motor 201 until the insert 120 is attached to the bell 110 to prevent dissatisfactory food processing. Alternatively or additionally to this, the central processing unit 203 may indicate to the user via the user interface 202 that the insert 120 should be attached responsive to feedback from the presence-sensor.

The shaft-alley 101, shaft 102, bell 110, insert 120, and/or knife 130 are preferably made of dishwasher-safe materials. “Dishwasher safe” means that it should be physically and chemically stable during prolonged exposure to the conditions prevailing within a dishwasher machine. For example it should be able to withstand repeated exposure to a mixture of water and a typical dishwasher cleaning agent at temperatures of 82 degrees centigrade for as long as 8 hours without visibly degrading (e.g., cracking). They may be made of stainless steel, which advantageously is also food-safe. As another example they may lack any lubricating oils which may dry out during washing in a dishwasher machine, and may instead use dry lubricants such as, for example, a PTFE-based dry lubricant, or indeed no lubricant. Making the insert 120 and bell 110 out of the same metal also facilitates welding together of them.

The shaft-alley 101, shaft 102, bell 110, insert 120, and/or knife 130 are preferably made of food-safe materials. “Food safe” in this context means any substance that does not, under ordinary kitchen conditions, shed substances harmful to human health in significant quantities. For example, they should be BpA-free.

As discussed above, the insert 120 may be stamped, punched, or cut out of sheet metal to form a blank. The ribs 121 and boss 122 of the insert may be then formed by stamping and/or deep drawing of the sheet metal blank. Alternatively or additionally the ribs 121 and/or boss 122 may be formed simultaneously with the punching out of the peripheral shape of the insert 120. These are relatively cheap, simple, and easily-repeatable ways of machining sheet-metal.

It will be understood that the present invention has been described above purely by way of example, and modifications of detail can be made within the scope of the invention.

Each feature disclosed in the description, and (where appropriate) the claims and drawings may be provided independently or in any appropriate combination.

Reference numerals appearing in the claims are by way of illustration only and shall have no limiting effect on the scope of the claims.

1-15. (canceled)

16. A food processing tool having a housing defining a volume therein, the tool comprising:
a drive-shaft configured to drive a bladed tool attached thereto about an axis of rotation; and
an insert located and arranged in the housing so as to define a processing volume open to an outside of the housing through an opening thereof;
wherein the insert is integral with the housing.

17. The food processing tool of claim 16 wherein the insert comprises ribs extending from a surface of the insert into the processing volume.

18. The food processing tool of claim 17 wherein the ribs are separated from the housing by a gap, and the insert is welded to the housing, preferably wherein the gap is at least 1 mm, more preferably at least 2.5 mm and yet more preferably is in the range 2.5-3 mm.

19. The food processing tool of claim 17, wherein the ribs extend radially substantially at a right-angle to the axis of rotation over the majority of their length, and preferably extend either directly radially, and not tangentially, from a central boss of the insert or from an imaginary cylinder concentric with the axis of rotation.

20. The food processing tool of claim 17 wherein the ribs each respectively comprise a forward slope, and a reverse slope, wherein a minimum angle formed by the forward slope relative to a direction of rotation of the bladed tool is steeper than that of the reverse slope, and more preferably the forward slope forms an angle of approximately 45 degrees.

21. The food processing tool of claim 17, wherein the ribs curve away from a direction of rotation of the bladed tool, and preferably wherein the ribs are curved to conform to a spiral/twisted shape of the housing and/or a curvature of blades of the bladed tool.

22. The food processing tool of claim 16, wherein the housing comprises radial maxima and minima configured to guide food flowing around an inside of the housing away from the housing, preferably wherein the insert is shaped to conform to the radial maxima and minima.

23. The food processing tool of claim 22, wherein the opening of the housing comprises axial maxima and minima, preferably wherein the radial maxima and minima respectively correspond to the axial maxima and minima.

24. The food processing tool of claim 16, wherein the insert is sealingly welded to the housing so as to seal against liquid ingress between the housing and the insert.

25. The food processing tool of claim 16 wherein less than 70% of an internal surface area of the housing is covered by the insert.

26. The food processing tool of claim 16, wherein the housing and the insert are made of dishwasher and/or food-safe material, preferably stainless steel.

27. The food processing tool of claim 16, wherein an exterior of the housing forms a maximum angle of 90 degrees or more to the axis of rotation, preferably 135 degrees or more, and more preferably still is bell-shaped.

28. A food processing tool comprising a rotary knife and a housing comprising a roof surrounding the rotary knife axially on one side, and a skirt surrounding the knife radially about a periphery of a volume of rotation of the knife, wherein the skirt comprises protrusions extending radially inwards towards the volume of rotation of the knife and the roof comprises ribs extending axially towards the knife and radially between the protrusions.

29. A food processing appliance comprising the tool of claim 16.

30. A method of manufacturing a food processing tool, comprising:
a) stamping, punching, or cutting sheet metal to produce a shaped blank,
b) stamping and/or deep-drawing the blank to produce an insert bearing ribs, preferably ribs that do not extend all the way to an edge of the insert, and
c) welding, preferably laser-welding, the insert to a housing,
preferably, wherein step a) and step b) are carried out simultaneously and/or by stamping/punching with the same die.
